(19) United States
(12) Patent Application Publication
(10) Pub. No.: US 2015/0371166 A1
(43) Pub. Date: Dec. 24, 2015

(54) System To Input And Calculate Lien Requirements On A Single Page Dynamic Interface

(71) Applicant: Scott Gerard Wolfe, JR., New Orleans, LA (US)

(72) Inventor: Scott Gerard Wolfe, JR., New Orleans, LA (US)

(21) Appl. No.: 14/309,340

(22) Filed: Jun. 19, 2014

(51) Int. Cl. G06Q 10/06

(52) U.S. Cl. CPC G06Q 10/06313

(57) ABSTRACT

A system and method, using a computer or computer program, that displays to the user a single page for inputting certain information about a construction project or open account—and uses that information to dynamically determine applicable products/documents and associated deadlines and display those products and associated deadlines to the user. Once the system determines the appropriate product/documents and the deadlines associated with them, the user is enabled to order any of the applicable products/documents on the same screen/display by clicking on the document name. The calculation and/or determination of the applicable document is made pursuant to a system and method, using a computer or computer program, of associating particular documents to various combinations of certain variables, including project location, project type, the user's role in the project, the role of that party who hired the user, and certain “trigger dates”.

### CROSS REFERENCE TO RELATED APPLICATIONS

This Nonprovisionsal Utility Patent Application claims the benefit of a previously filed provisional patent under 35 USC 199(e), the application number of which is 61/836,751.

### STATEMENT REGARDING FEDERALLY SPONSORED RESEARCH OR DEVELOPMENT

Not applicable.

### REFERENCE OF SEQUENCE LISTING, A TABLE, OR A COMPUTER PROGRAM LISTING COMPACT DISC APPENDIX

Not Applicable

### BACKGROUND OF THE INVENTION

The present invention relates to the field of mechanics lien and bond claim compliance.

Mechanics lien and bond claim compliance is an important compliance item for construction industry participants, including general contractors, subcontractors, other trade contractors, architects, engineers, suppliers, and others. The compliance framework, however, is extraordinarily complex, governed by statutes and case law that differs depending on a construction project's jurisdiction, and characteristics of the construction project itself.

For quite some time, individuals and companies have offered resources to help construction participants understand and calculate the timeframe available to them to file construction notices, liens and bond claims across the country.

Most of these resources have been in paper format, simply separating the lien laws and lien law charts by state, and providing readers with a table of contents to the data. Some paper resources are more sophisticated, allowing users to move cardboard forms within a cardboard capsule so that a particular state will display in a carved out window; when a state is selected, that state's lien laws (or a summary thereof) will be displayed. Still, however, the reader would have to decipher which laws apply to their particular station. Further, these lien law summaries are merely a compilation of the lien laws across the United States and its territories.

This invention creates a system and method, using a computer or computer program, that displays to the user a single page, and allows the user to input specific information on that page about a construction project or open account—and uses that information to dynamically determine applicable products/documents and associated deadlines and display those products and associated deadlines to the user. Once the system determines the appropriate product/documents and the deadlines associated with them, the user is enabled to order any of the applicable products/documents on the same screen/display by clicking on the document name. The calculation and/or determination of the applicable document is made pursuant to a system and method, using a computer or computer program, of associating particular documents to various combinations of certain variables, including project location, project type, the user's role in the project, the role of that party who hired the user, and certain “trigger dates”.

### SUMMARY OF THE ART

### Mechanics Liens and Notices

Those furnishing labor, materials and/or services to private, state and federal construction projects around the United States have possible “mechanic's lien” claims in the event they are unpaid for their contribution. Popularly referred to as a “mechanic's lien,” the legal remedy is also called a “claim of lien,” “materialmen's lien,” “property lien,” “contractor lien,” “construction lien,” “statement of claim and privilege,” “notice of claim of lien,” and “stop work order.” When the labor, materials or services are furnished to a construction project owned privately (non-governmental ownership), the lien is placed against the property itself. When the labor, materials or services are furnished to a state or federal construction project, a lien against the government owned property is typically not available, but instead a “lien” is made against a bond under the federal Miller Act or each individual state's “Little Miller Act.” This lien remedy, which goes by many names and has different characteristics depending on the construction project's type, is referred to herein collectively as a “mechanic's lien.”

While the ability to file a mechanic's lien is uniformly available across the United States and its territories, the laws regulating its filing differs from state-to-state. In addition to each state having unique mechanic's lien laws, within these laws different treatment is afforded to construction participants depending on their role in the project (i.e. original contractor, subcontractor, architect, supplier, equipment lessor, etc), their tier in the project (i.e. their place in the contractual chain starting from the property owner or public entity commissioning work) and the type of construction project where services are furnished (i.e. commercial, residential, owner-occupied residential, industrial, oil & gas, state, federal, etc.).

To preserve one's right to file a mechanics lien, many states require project participants to meet pre-lien statutory notice requirements. In some states, notices are required before services are provided, and in others notices are required within a certain period before the lien is filed. In other states, notices are not required at all. These notices must meet statutory requirements, and must be sent according to the state's statutory service or delivery standards. These construction notices, include, but are not limited to, notices of the following names and types: preliminary notices, pre-lien notices, notices to owner, notices of commencement, notices of intent to lien, notices of furnishing labor/materials, notices of lease, model disclosures, notices of completion or cessation, notices of lease, etc. Similar to a mechanic's lien, each state has specific requirements for how and when notices must be filed, served, or sent, to whom notices must be filed, served, or sent, and what must be included on the notice. These notices differ from mechanic's liens in that the notices are only preliminary documents necessary to retain the right to claim a mechanic's lien at a later date. The preliminary notices, where and when required, are necessary to claim a mechanic's lien, but are not sufficient, by themselves, for a mechanic's lien.

Each notice has specific and varied legal requirements, regarding who is to be given notice, how they must be given notice, and when the notice must be given. In some states, the notices are required to be given on a recurring basis for every month in which the potential lien claimant is unpaid for their work. The legal requirements for construction notices also vary by the role of the party giving notice (i.e. general contractor, subcontractor, material supplier, equipment lessor, etc.), as well as by the state in which the project was located, and the project type (i.e. commercial, residential, public, etc.).

The act of filing a mechanics lien is also subject to varied legal requirements, with each state setting forth specific elements required within a mechanic's lien. The legal requirements necessary to properly claim a mechanic's lien vary as to the time deadlines by which the lien must be filed, where/in what office the lien must be filed, and to whom and when notice of the lien itself must be delivered to certain other parties. After a lien is filed, many states require the mechanic's lien be served upon certain parties through pre-defined methods.

Notices, liens, bond claims, and other construction documents generally have deadlines by which the document must be filed or delivered, but it can potentially be useful to know the date requirement if the actual date deadline cannot be calculated. For example, if the deadline to send a notice is 15 days from the first furnishing of labor and or materials on a project, and the first date on furnishing is unknown—no deadline can be generated. However, the requirement itself can still be generated and shown to a party, i.e. the notice must be sent within 15 days of first furnishing labor and/or materials, and that information by itself may have some utility.

Finally, the mechanic's lien is a temporary encumbrance on private property or a surety bond. The encumbrance lasts for a specific period of time as provided by each jurisdiction's statute, and the encumbrance expires at the end of this time period unless action is taken by the lien claimant. In some jurisdictions, the mechanic's lien claim may be “extended” through a supplemental filing. When unable to extend or further extend a lien, the mechanic's lien claim must be “foreclosed upon” by filing an action seeking foreclosure in a designated court of law.

Calculating mechanics lien, bond claim and construction notice deadlines accurately requires the collection of certain information. Since each state's laws are different, a piece of data that matters in one state may not matter in another state. So, for example, whether the project is residential or commercial may make a difference in Washington, but not in California.

Accordingly, acquiring the data that is necessary to calculate requirements and deadlines is a difficult endeavor because what data is needed varies by situation. This is especially difficult when a single user of a system has projects in multiple territories, because the differences are most pronounced by the differing jurisdictional laws.

It is impossible to acquire just one set of data points that will apply across all project types, states and scenarios.

### Web Applications, Mobile Applications, and Widgets

The World Wide Web (WWW) is a well-known network of computers, whereby users around the world can access information displayed within a web browser. Typically the user accesses certain web pages that are displayed to the user through the HTML (HyperText Markup Language) protocol. The user calls and retrieves specific HTML pages by requesting the page through a known URL (Uniform Resource Locator) using HTTP (HyperText Transfer Protocol).

Using certain computer languages such as PHP, Javascript, and HTML, listed here as illustrative examples only, it has become common for companies and individuals to write applications that run and operate through web browsers on the world wide web. These web applications are similar to software applications that are written to operate on a user's desktop, except that they run through web browsers on the web.

Typically, a user will visit a certain website and be required to login to their account. Once logged in, the user will have access to the web application and its features. A web application can be designed to appear on a web browser access via a personal computer, or on a “mobile browser,” which is a web browser optimized for viewing on a mobile device.

Although web applications viewing on a standard web browser may be viewed on a mobile device through a mobile web browser, mobile devices also have the ability to run native mobile applications. These applications are optimized to operate on a mobile device (such as an iPhone or iPad, or an Android OS device) with or without the use of an internet connection. The user opens the application on his or her mobile device and is able to view, alter and interact with the application without the use of a browser.

Next, a Product Ordering Interface is an interface on the WWW that a user accesses through an HTTP request. Here, the user will find the ability to order certain products from the website, including, in the instance of this invention, mechanic's liens, bond claim forms, notices, lien cancellations, and similar products.

Finally, a “widget” is a term of art defined by Wikipedia as “a small application that can be installed and executed within a web page by an end user.” Or more further described therein as “a stand-alone application that can be embedded into third party sites by any user on a page where they have rights of authorship.” Other terms used to describe web widgets include: portlet, gadget, badge, module, webjit, capsule, snippet, mini and flake.

A widget may be installed on any web page, displaying content to the viewer, or offering a certain application or function to the viewer. When an application or function is offered, the widget runs a script stored on the originating server, such that the viewer is able to complete a function within the widget without the host-site storing the function's code and framework.

### Deadline Calculators and Lien Deadline Information Databases

For quite some time, individuals and companies have offered resources to help construction participants understand and calculate the timeframe available to them to file construction notices, liens and bond claims across the country.

Most of these resources have been in paper format, simply separating the lien laws and lien law charts by state, and providing readers with a table of contents to the data. Some paper resources are more sophisticated, allowing users to move cardboard forms within a cardboard capsule so that a particular state will display in a carved out window; when a state is selected, that state's lien laws (or a summary thereof) will be displayed. Still, however, the reader would have to decipher which laws apply to their particular station. Further, these lien law summaries are merely a compilation of the lien laws across the United States and its territories.

With the advent of computer software and the Internet, lien law resources have gotten a bit more usable.

Software users and web visitors have a few options where they can use computer databases to decode some of the lien law information. For instance, a user using one of these databases can select their state and be shown the general lien law in that state. In another instance, which is more specific, the user may use a software application to house detailed information about their construction project and the system will—after gathering all this project information—ask the user to provide generic work performance dates and/or answer pre-programmed questions about the project, and from all this information, display more specific database information about the construction project's applicable lien laws.

In addition to applications and database information systems that provide information about lien laws, there are a variety of generic date/deadline calculators in the marketplace. These calculators typically calculate a set number of days, months or years from a given date, and schedule notifications when the deadline approaches.

However, all of the generic deadline calculators and more specific database systems for construction liens are inefficient in that: (i) They do not offer deadline information completely customized to the user's specific project and services; (ii) They are inefficient in that they request a substantial amount of information to associate it with the applicable deadline; (iii) They are part of a more complex project management software; (iv) They fail to request the correct “trigger dates” that are tailored to the project and the user; (v) They lack a easy-to-use backend for administrators to create deadline types without the use of coding; and (vi) They are inefficient in that they give no guidance to the user to ensure they are properly calculating their deadline.

### BRIEF SUMMARY OF THE INVENTION

This invention, through a computer or computer program, creates a system that displays to the user a single page for inputting certain information about their construction project or open account—and uses that information to dynamically determine applicable products and deadlines and display those products and deadlines. The user may then order any document via that display by clicking on the document name.

The example use and implementation of this invention, referred to through this application, is the determination of which documents, such as a mechanics lien claim or specific preliminary notice, is required for a particular user on a particular project, based on user provided information and the relation of this information to particular requirements, and those documents' specific deadlines, and the ability to order any of the applicable documents by clicking on the name of the document on the same display page. This imputing of information and display of the corresponding applicable documents/deadlines and ordering capability is all contained within a one-page dynamic interface displayed to the user.

### BRIEF DESCRIPTION OF THE DRAWINGS

FIG. 1 displays the user interface, and the location and type of the information to be input. Additional information will be available to the user to input, but that information is not accessible yet on the single page interface, as the exact options for the remaining input areas will depend on the users inputs.

FIG. 2 displays the user interface, specifically for the input of the “trigger dates” FIG. 2.1, and the display of the applicable and available documents determined by the information input by the user FIG. 2.2.

FIG. 3 displays the user interface/display by which the system displays the applicable deadlines as determined by the information input by the user—and information about those deadlines. The user is able to click on the deadline reference to order the product which satisfies that deadline.

### DETAILED DESCRIPTION OF THE INVENTION

This invention creates a system, using a computer or computer program, that displays to the user a single page for inputting certain information about their construction project or open account—and uses that information to dynamically determine applicable products and deadlines and display those products and deadlines. The user may then order any document via that display by clicking on the document name.

Certain set information is required to be inputted and the invention then dynamically requests additional information based on the previously entered information. After the information is entered the invention systematically examines a database and displays all applicable products available, the deadlines applicable to each product, and information about each product, dynamically—based on the information provided by the user.

The information requested from the user includes (i) The state where the project is located; (ii) The role of the party who hired the user and/or the tier of the user in the construction contracting chain; and (iii) The type of construction project, whether it be commercial, residential, private, state, or federal.

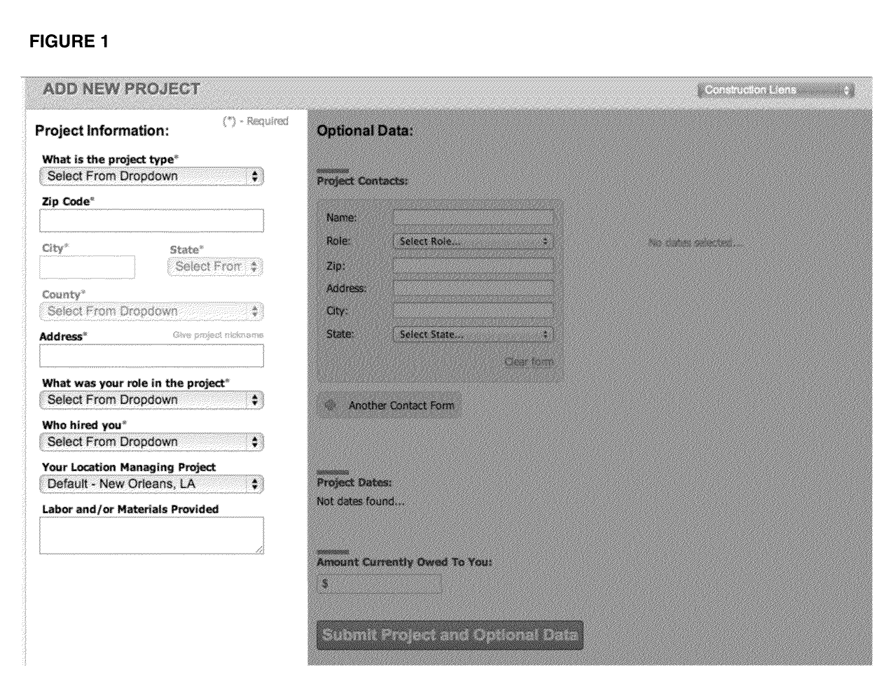

Additional information will be available to the user to input, but that information is not accessible yet on the single page interface, as the exact options for the remaining input areas will depend on the users inputs. This is demonstrated in FIG. 1.

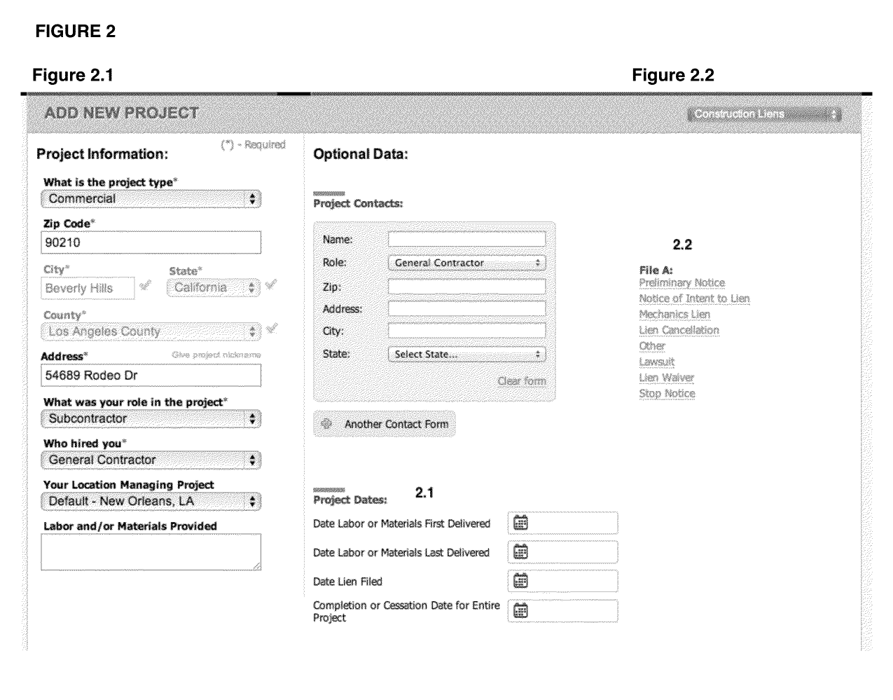

Once the user inputs the key data points above identified as (i), (ii) and (iii), the system performs three functions:
(1) It selects the “role” of the party that hired the user and asks for the contact information for this identified party;
(2) It determines which dates are “trigger dates” in the system, pursuant to patent application Ser. Nos. 13/490,645 and 13/490,781, and allows for the user to input these dates into the system, see FIG. 2, 2.1;
(3) It examines the database to identify every applicable product available to the user based on the entered criteria, and it displays those available documents to the user. The user is able to click on any document reference to order the document, in a method described in patent application Ser. No. 13/490,749, see FIG. 2, 2.2.

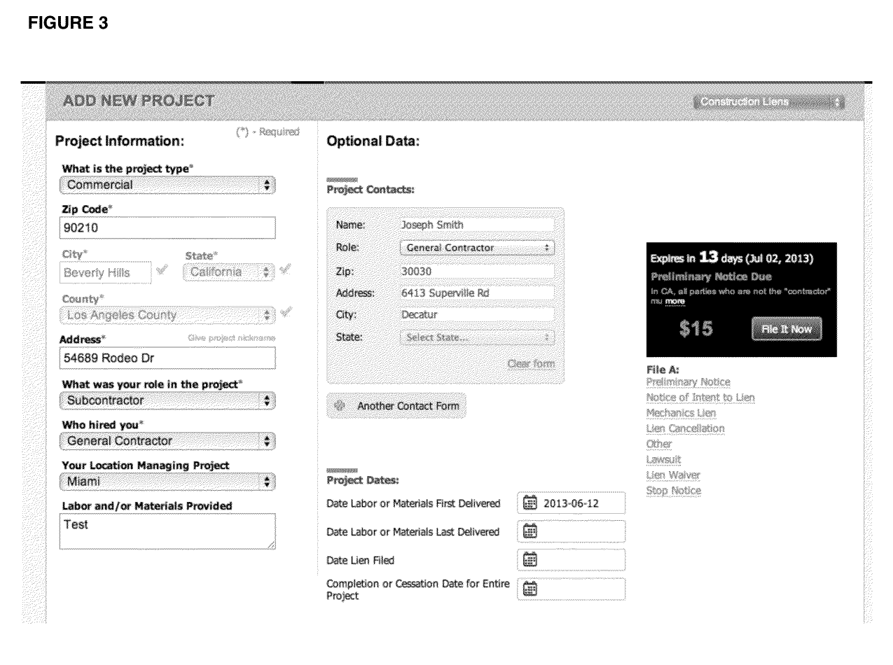

When the user inputs any requested dates, the system analyzes the database and calculates the applicable deadlines. These deadlines are then displayed to the user, along with information about the same, and the user is able to click on the deadline reference to order a satisfying product or document, as described in patent application Ser. No. 13/490,749, see FIG. 3.

In addition to being able to click on the product or document references to order the same, the user is also allowed to simply submit the project information without ordering any product or document. The submitted project information is stored into the system's database.

A system and method, using a computer or computer program, that displays to the user a single page for inputting certain information about their construction project or open account—and uses that information to dynamically determine applicable products and deadlines and display those products and deadlines. The user may then order any document via that display by clicking on the document name.

What is claimed is:

1. A computer displayed method and system of calculating and determining applicable documents determined by a specific user's inputted information, displayed on a single page, and accomplished through the method comprising the steps of:
a. Displaying to a user through a computer or mobile interface, a single page for inputting project information, including 1) the state where the project is located; 2) The role of the party that hired the user; and 3) The type of construction project (commercial, residential, private, state, or federal).
b. Using the information inputted by the user to dynamically request additional information based on the previously entered information, such as the appropriate “trigger dates” applicable to the project based on the user inputted data
c. Systematically examining a computer database file, program, database, other data source, or set of information, to identify each potential document, i.e. Preliminary Notice, Mechanics Lien, Bond Claim, etc., applicable to a particular set of user inputted data;
d. Displaying to a user through a computer or mobile interface, a single page display containing all available documents applicable to the specific project information which they input;

2. A computer displayed method and system of calculating and determining applicable deadlines, displayed on a single page, and determined by a specific user's inputted information, through the method comprising the steps of:
a. Displaying to a user through a computer or mobile interface, a single page for inputting project information, including 1) the state where the project is located; 2) The role of the party that hired the user; and 3) The type of construction project (commercial, residential, private, state, or federal).
b. Using the information inputted by the user to dynamically request additional information based on the previously entered information, such as the appropriate “trigger dates” applicable to the project based on the user inputted data.
c. Systematically querying/examining a computer file, program, database, other data source, or set of information to identify each potential document, i.e. Preliminary Notice, Mechanics Lien, Bond Claim, etc., applicable to a particular set of user inputted data;
d. Systematically querying/examining a computer file, program, database, other data source, or set of information to identify each applicable deadline date related to the specific documents displayed in step c, above, i.e. Preliminary Notice, Mechanics Lien, Bond Claim, etc., applicable to the users set of inputted data;
e. Displaying to the user, via computer or mobile device, a single page display containing the specific documents applicable to their information set, and the specific deadlines related to each of the specific applicable documents.

3. The method of claim 1 wherein the documents and deadlines displayed on the single page are calculated by the system, through the computer or computer program, and not selected by the user, through the method comprising the steps of:
a. Storing, by the computer or computer program into a computer system, file, program, database, or data source, individual records identifying document types and specific documents, associated with a different sets of user provided data;
b. Storing, by the computer or computer program into a computer system, file, program, database, or data source, an identification as to which deadline applies to which document, given the specific set of data supplied by the user;

4. A computer displayed method and system of enabling the user to order any of the applicable documents displayed on the single page user interface display by clicking on the individual document the user wishes to order.
a. Displaying to the system user, through a computer or device user interface, a button, hyperlink, or some clickable figure to initiate the order of the product;
b. Retrieving, by the computer or computer program, from the database, the product identifier for the product ordered;
c. Examining, by the computer or computer program, the identified product record in the database, which contains a textual document or form, to identify what data elements are required to be filled within the form through some document assembly process;
d. Retrieving, by the computer or computer program, from the database:
i. Stored data records associated with the system user; and
ii. Stored data records associated with the system user's project, which is the subject of the generated or displayed deadline described in claim 1 and contemplated by this claim 4 (the “project record”)
e. Examining, by the computer or computer program, the required data elements identified in subpart (c) of this claim 4, and comparing them to the stored data identified in subpart (d) of this claim 4, and identifying all required data elements that are not fulfilled by the available stored data (the “missing data elements”);
f. Retrieving, by the computer or computer program, from the database, the textual name given to the missing data elements identified in subpart (e) of this claim 4;
g. After the system user has performed the single action (i.e. button click) to initiate the order of the product, and the system has performed the above-contemplated process to determine the missing data elements, displaying to the system user, through a computer or device user interface, the textual names of all the missing data elements; and
h. Enabling the user, through a computer or computer program, within the computer or device interface, to input into an input field the missing data elements, with said data elements being entered into and stored within the database and associated with the identified project record, and the ordered product.
